(19) United States
(12) Patent Application Publication
(10) Pub. No.: US 2025/0282976 A1
(43) Pub. Date: Sep. 11, 2025

(54) CROSSLINKED POLYSILAZANE AND COMPOSITION COMPRISING THE SAME

(71) Applicant: Merck Patent GmbH, Darmstadt (DE)

(72) Inventors: Kousuke Kabasawa, Shizuoka (JP); Atsuhiko Sato, Shizuoka (JP); Hideyuki Takagishi, Shizuoka (JP)

(21) Appl. No.: 19/214,574

(22) Filed: May 21, 2025

Related U.S. Application Data
(63) Continuation of application No. PCT/EP2023/082822, filed on Nov. 23, 2023.

(30) Foreign Application Priority Data
Nov. 25, 2022 (JP) 2022-188532

(51) Int. Cl. C09D 183/16; C08G 77/54; C08G 77/62; C09D 7/20; C09D 183/14

(52) U.S. Cl. CPC C09D 183/16; C08G 77/54; C08G 77/62; C09D 7/20; C09D 183/14

(57) ABSTRACT

A crosslinked polysilazane includes a repeating unit represented by the formula (1) as defined herein:

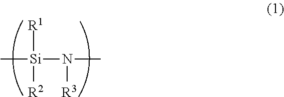

### CROSS-REFERENCE TO RELATED APPLICATIONS

This application is a Continuation under 35 USC § 111 (a) of International Patent Application No. PCT/EP2023/082822 filed Nov. 23, 2023, which claims priority to the JP Application No. 2022-188532 filed on Nov. 25, 2022. The entire contents of these applications are incorporated herein by reference in their entirety.

### BACKGROUND OF THE INVENTION

### Field of the Invention

The present invention relates to a crosslinked polysilazane. Further, the present invention also relates to a composition comprising a crosslinked polysilazane and a solvent, a silicon-containing film, a method for manufacturing a crosslinked polysilazane, and a method for manufacturing a silicon-containing film.

### Background Art

During manufacture of electronic devices, especially semiconductor devices, an interlayer insulating film may be formed between a transistor element and a bit line, between a bit line and a capacitor, between a capacitor and a metal wiring, between plural of metal wirings, and the like. Further, an insulating material may be filled in isolation trenches provided on a substrate surface or the like. Furthermore, after forming a semiconductor device on a substrate surface, a coating layer may be formed using a sealing material to provide a package. The interlayer insulating film and the coating layer are often formed from a silicon-containing material.

A chemical vapor deposition method (CVD method), a sol-gel method, a method for applying a composition comprising a silicon-containing polymer and baking, and the like are used for a method for forming a silicon-containing film such as a siliceous film, a silicon nitride film, a silicon carbide film or a silicon carbonitride film. Among these methods, a method for forming a silicon-containing film using a composition that includes a silicon-containing polymer is often employed since it is relatively simple. Examples of the silicon-containing polymer include polysilazane, polysiloxane, polycarbosilane, polysilane, and the like.

A polysilazane has the property of being converted into a siliceous substance by heating. When a general polysilazane is used singly, there are objectives that can be improved such as difficulty in increasing the film thickness, slow conversion rate to a siliceous substance, and necessity of a high temperature for conversion to a siliceous substance, and various studies have been made to improve such points. For example, studies have focused on improvement of the above problems by modifying the polysilazane itself or by combining a certain additive with a polysilazane-containing composition. For example, U.S. Pat. No. 4,689,252 discloses a crosslinkable composition that includes a polysilazane having a certain unsaturated hydrocarbon group.

### SUMMARY OF THE INVENTION

The present invention has been made in view of the above-described circumstances, and its object is to provide a new crosslinked polysilazane and a composition comprising the crosslinked polysilazane. A silicon-containing film formed using the crosslinked polysilazane can be made thicker than before and is sufficient in crack resistance even in a thick film.

A crosslinked polysilazane according to the present invention comprises a repeating unit represented by the following formula (1):

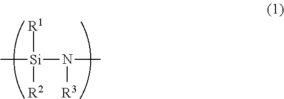

wherein,
R¹ and R² are each independently a single bond, hydrogen, C₁₋₄ alkyl or a linking group represented by the formulae (a) to (c), and when R¹ and R² are a single bond, they are bonded to N contained in other repeating units, and in the crosslinked polysilazane molecule, at least two of R¹ and R² are linking groups represented by the formulae (a) to (c);
R³ is a single bond, hydrogen or C₁₋₄ alkyl, and when R³ is a single bond, it is bonded to Si contained in other repeating units:

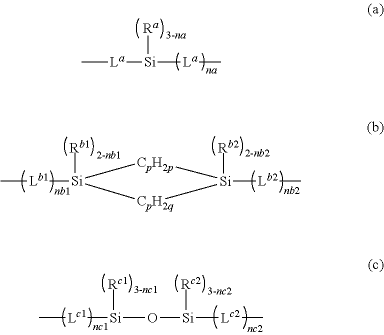

R^{a}, R^{b1}, R^{b2}, R^{c1} and R^{c2} are each independently hydrogen, C₁₋₆ alkyl, C₁₋₆ alkenyl or C₆₋₁₂ aryl;
L^{a}, L^{b1}, L^{b2}, L^{c1} and L^{c2} are each independently C₂₋₈ alkylene or C₆₋₁₄ arylene, in which the methylene in the alkylene and the arylene is not replaced or is replaced with oxy, provided that when it is replaced with oxy, the oxy is not directly bonded to Si of the formula (1);
na is 1 to 3;
nb1 and nb2 are each independently 1 to 2;
nc1 and nc2 are each independently 1 to 3;
p and q are each independently 1 to 3; and
among the bonds of the linking groups of the formulae (a) to (c), the bonds that are not bonded to Si of the formula (1) are bonded to Si contained in other repeating units.

A method for manufacturing a crosslinked polysilazane according to the present invention comprises:
heating or irradiating with light, in the presence of a reaction initiator, a polysilazane comprising a repeating unit represented by the formula (2) and at least two Si—H bonds; and at least one silicon compound represented by the formulae (d) to (f):

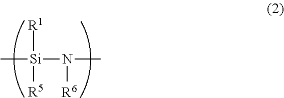

wherein,
R⁴ and R⁵ are each independently a single bond, hydrogen or C₁₋₄ alkyl, and when R⁴ and R⁵ are a single bond, they are bonded to N contained in other repeating units; and
R⁶ is a single bond, hydrogen or C₁₋₄ alkyl, and when R⁶ is a single bond, it is bonded to Si contained in other repeating units; and

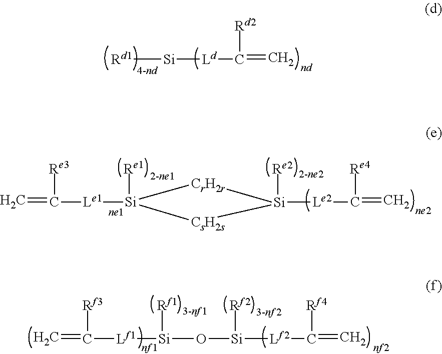

R^{d1}, R^{e1}, R^{e2}, R^{f1} and R^{f2} are each independently hydrogen, C₁₋₆ alkyl, C₁₋₆ alkenyl or C₆₋₁₂ aryl;
R^{d2}, R^{e3}, R^{e4}, R^{f3} and R^{f4} are each independently hydrogen or C₁₋₆ alkyl;
L^{d}, L^{e1}, L^{e2}, L^{f1} and L^{f2} are each independently a single bond, C₁₋₆ alkylene or C₆₋₁₂ arylene, in which the methylene of the alkylene and the arylene is not replaced or replaced with oxy;
nd is 2 to 4;
ne1 and ne2 are each independently 1 to 2;
nf1 and nf2 are each independently 1 to 3; and
r and s are each independently 1 to 3.

A composition according to the present invention comprises the above-described crosslinked polysilazane and a solvent.

A method for manufacturing a silicon-containing film according to the present invention comprises:
forming a coating film above a substrate with the above-described composition; and
heating the coating film.

A silicon-containing film according to the present invention is obtainable by the above-described method.

A method for manufacturing an electronic device according to the present invention comprises the above-described method.

The present invention has been made in view of the above-described circumstances, and its object is to provide a new crosslinked polysilazane and a composition comprising the crosslinked polysilazane. A silicon-containing film formed using the crosslinked polysilazane can be made thicker than before and is sufficient in crack resistance even in a thick film.

According to the present invention, a new crosslinked polysilazane and a composition comprising the crosslinked polysilazane are provided. A silicon-containing film formed using the crosslinked polysilazane can be thickened and is sufficient in crack resistance.

### BRIEF DESCRIPTION OF THE DRAWINGS

FIG. 1 shows measurement results of ¹³C-NMR of a crosslinked polysilazane according to the present invention; and

FIG. 2 shows measurement results of ²⁹Si-NMR of a crosslinked polysilazane according to the present invention.

### DETAILED DESCRIPTION OF THE INVENTION

Unless otherwise stated, terms used in the present specification shall have the following meanings.

In the present specification, the use of the singular includes the plural, and the words “a”, “an” and “the” mean “at least one”, unless specifically stated otherwise. Unless otherwise specified in the present specification, an element of a concept can be expressed by a plurality of species, and when the amount (for example, mass % or mol %) is described, it means sum of the plurality of species. The term “and/or” refers to any combination of the foregoing elements including using a single element.

In the present specification, when a numerical range is indicated using “to” or “-”, it includes both endpoints and units thereof are common. For example, 5 to 25 mol % refers to that 5 mol % or more and 25 mol % or less.

In the present specification, alkyl means a group obtained by removing any one hydrogen from a linear or branched, saturated hydrocarbon and includes a linear alkyl and branched alkyl, and cycloalkyl means a group obtained by removing one hydrogen from a saturated hydrocarbon comprising a cyclic structure and optionally includes a linear or branched alkyl in the cyclic structure as a side chain.

In the present specification, alkenyl means a group obtained by removing any one hydrogen from a linear or branched hydrocarbon which has a carbon-carbon double bond.

In the present specification, the descriptions such as “C_{x-y}”, “Cₓ-C_{y}” and “Cₓ” mean the number of carbons in a molecule or substituent. For example, C₁₋₆ alkyl means alkyl having 1 or more and 6 or less carbons (methyl, ethyl, propyl, butyl, pentyl, hexyl etc.). Fluoroalkyl as used in the present specification means one in which one or more hydrogens in alkyl are replaced with fluorine, and fluoroaryl means one in which one or more hydrogens in aryl are replaced with fluorine.

In the present specification, when polymer has plural types of repeating units, these repeating units copolymerize. These copolymerization may be any of alternating copolymerization, random copolymerization, block copolymerization, graft copolymerization, or a mixture thereof.

In the present specification, “%” means “mass %” and “parts” means “parts by mass”.

In the present specification, Celsius is used as the temperature unit. For example, 20 degrees means 20 degrees Celsius.

Embodiments of the present invention are described below in detail.

### <Crosslinked Polysilazane>

The crosslinked polysilazane according to the present invention comprises a repeating unit represented by the following formula (1):

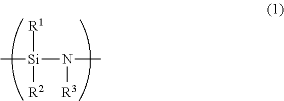

wherein,
R¹ and R² are each independently a single bond, hydrogen, C₁₋₄ alkyl or a linking group represented by the formulae (a) to (c), preferably a single bond, hydrogen or a linking group represented by the formulae (a) to (c). when R¹ and R² are a single bond, they are bonded to N contained in other repeating units, and in the crosslinked polysilazane molecule, at least two of R¹ and R² are linking groups represented by the formulae (a) to (c).
R³ is a single bond, hydrogen or C₁₋₄ alkyl, preferably a single bond or hydrogen. When R³ is a single bond, it is bonded to Si contained in other repeating units.

Examples of the linking group represented by the formula (a) include:

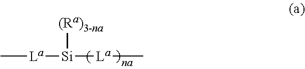

wherein,
R^{a}'s are each independently hydrogen, C₁₋₆ alkyl, C₁₋₆ alkenyl or C₆₋₁₂ aryl, preferably, methyl, ethyl, vinyl, allyl, or phenyl.
L^{a}'s are each independently C₂₋₈ alkylene or C₆₋₁₄ arylene, preferably C₂₋₆ alkylene, more preferably —CH₂—CH₂— or —CH₂—CH₂—CH₂—. Methylene in alkylene and arylene is not replaced or replaced with oxy, preferably is not replaced. However, when methylene is replaced with oxy, the oxy is not directly bonded to Si of the formula (1).
na is 1 to 3, preferably 2 or 3, and more preferably 3.

Among the bonds of the linking group of the formula (a), the bond that is not bonded to Si of the formula (1) is bonded to Si contained in other repeating units.

Exemplified embodiments of the linking group represented by the formula (a) include:

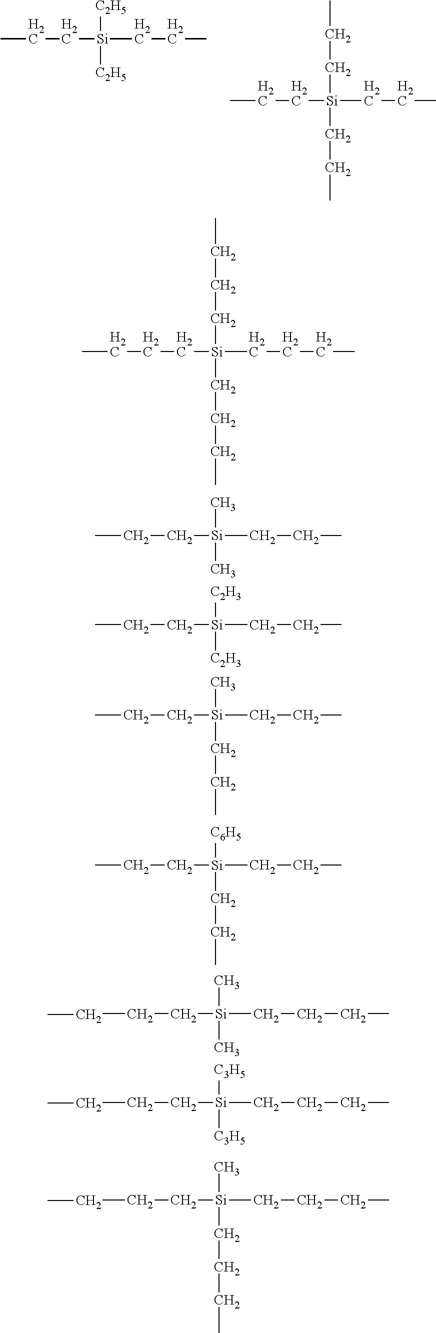

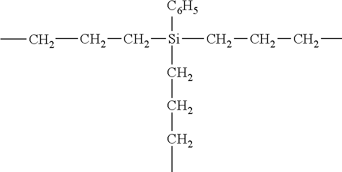

Examples of the linking group represented by the formula (b) include:

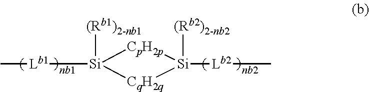

wherein,
R^{b1} and R^{b2} are each independently hydrogen, C₁₋₆ alkyl, C₁₋₆ alkenyl or C₆₋₁₂ aryl, preferably hydrogen or methyl.
L^{b1} and L^{b2} are each independently C₂₋₈ alkylene or C₆₋₁₄ arylene, preferably C₂₋₆ alkylene, more preferably —CH₂—CH₂— or —CH₂—CH₂—CH₂—. Methylene in alkylene and arylene is not replaced or replaced with oxy, preferably is not replaced. However, when methylene is replaced with oxy, the oxy is not directly bonded to Si of the formula (1).
nb1 and nb2 are each independently 1 to 2, preferably 2.
p and q are each independently 1 to 3, preferably 1 or 2, and more preferably 1.

Among the bonds of the linking group of the formula (b), the bond that is not bonded to Si of the formula (1) is bonded to Si contained in other repeating units.

Exemplified embodiments of the linking group represented by the formula (b) include:

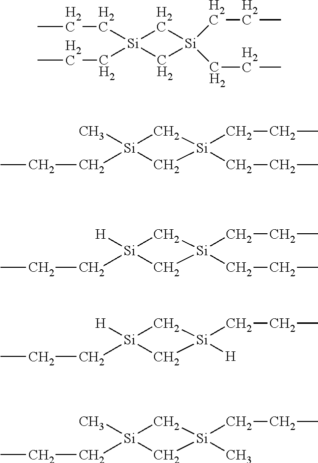

Examples of the linking group represented by the formula (c) include:

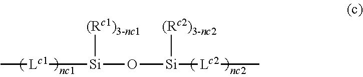

R^{c1} and R^{c2} are each independently hydrogen, C₁₋₆ alkyl, C₁₋₆ alkenyl or C₆₋₁₂ aryl, preferably C₁₋₆ alkyl, more preferably methyl or ethyl.
L^{c1} and L^{c2} are each independently C₂₋₈ alkylene or C₆₋₁₄ arylene, preferably C₂₋₆ alkylene, more preferably —CH₂—CH₂— or —CH₂—CH₂—CH₂—. Methylene in alkylene and arylene is not replaced or replaced with oxy, preferably is not replaced. However, when methylene is replaced with oxy, the oxy is not directly bonded to Si of the formula (1).
nc1 and nc2 are each independently 1 to 3, preferably 2.

Among the bonds of the linking group of the formula (c), the bond that is not bonded to Si of the formula (1) is bonded to Si contained in other repeating units.

Exemplified embodiments of the linking group represented by the formula (c) include:

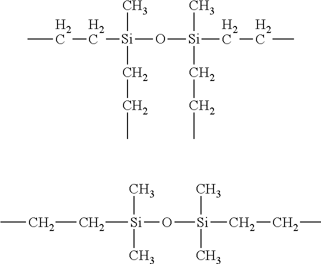

In the crosslinked polysilazane according to the present invention, the linking groups of the formulae (a) to (c) are a crosslinking group that links Si atoms in the silazane structure.

Examples of the partial structure of the crosslinked polysilazane according to the present invention include:

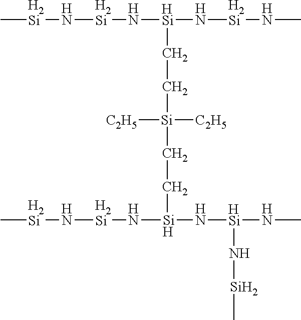

The crosslinked polysilazane according to the present invention preferably consists essentially of the repeating unit represented by the formula (1). In the present invention, “essentially” means that 95 mass % or more of all constitutional units contained in the crosslinked polysilazane are the repeating unit represented by the formula (1).

Further preferably, the crosslinked polysilazane comprises no repeating unit other than the repeating unit represented by the formula (1).

Preferably, the crosslinked polysilazane has a terminal group of —SiH₃.

The number of Si derived from the formulae (a) to (c) contained in the crosslinked polysilazane is preferably 0.5 to 10.0% and more preferably 0.8 to 9.0%, based on the total number of Si in the crosslinked polysilazane.

The mass average molecular weight of the crosslinked polysilazane is preferably 3,000 to 50,000, more preferably 4,000 to 40,000, and further preferably 5,000 to 35,000. Here, the mass average molecular weight is a mass average molecular weight in terms of polystyrene, which can be measured by the gel permeation chromatography based on polystyrene.

### <Method for Manufacturing Crosslinked Polysilazane>

A method for manufacturing a crosslinked polysilazane according to the present invention comprises
heating or irradiating with light, in the presence of a reaction initiator,
a polysilazane (hereinafter referred to as “raw material polysilazane”) comprising a repeating unit represented by the formula (2) and at least two Si—H bonds; and
at least one silicon compound (hereinafter referred to as “silicon compound”) represented by the formulae (d) to (f).

It is considered that the crosslinked polysilazane is formed, for example, by crosslinking polymers of the raw material polysilazane by a hydrosilylation reaction using a silicon compound as a crosslinking agent.

### <Raw Material Polysilazane>

The raw material polysilazane includes a repeating unit represented by the formula (2) and at least two Si—H bonds.

The formula (2) is as follows:

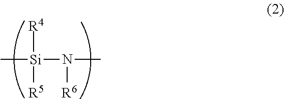

wherein,
R⁴ and R⁵ are each independently a single bond, hydrogen or C₁₋₄ alkyl, preferably a single bond or hydrogen. When R⁴ and R⁵ are a single bond, they are bonded to N contained in other repeating units.
R⁶ is a single bond, hydrogen or C₁₋₄ alkyl, preferably a single bond or hydrogen. When R⁶ is a single bond, it is bonded to Si contained in other repeating units.

The raw material polysilazane is preferably perhydropolysilazane (hereinafter referred to as “PHPS”). The PHPS is a polymer including a Si—N bond as a repeating unit, and composed only of Si, N, and H. In the PHPS, elements bonded to Si and N are all H except for a Si—N bond, and other elements such as carbon and oxygen are not essentially contained. The PHPS may have a branched structure or a cyclic structure in the molecule.

The mass average molecular weight of the raw material polysilazane is preferably 2,000 to 20,000 and more preferably 3,000 to 15,000, from the viewpoint of solubility in a solvent and reactivity. Here, the mass average molecular weight is a weight average molecular weight in terms of polystyrene, which can be measured by the gel permeation chromatography based on polystyrene.

### <Silicon Compound>

The silicon compound is at least one represented by the formulae (d) to (f).

The formula (d) is as follows:

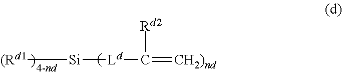

wherein,
R^{d1}'s are each independently hydrogen, C₁₋₆ alkyl, C₁₋₆ alkenyl or C₆₋₁₂ aryl, preferably, methyl, ethyl, or phenyl.
R^{d2}'s are each independently hydrogen or C₁₋₆ alkyl, preferably hydrogen or methyl, more preferably hydrogen.
L^{d}'s are each independently a single bond, C₁₋₆ alkylene or C₆₋₁₂ arylene, preferably a single bond or C₁₋₄ alkylene, more preferably a single bond or —CH₂—. Methylene in alkylene and arylene is not replaced or replaced with oxy, preferably is not replaced.
nd is 2 to 4, more preferably 4.

Exemplified embodiments of the silicon compound represented by the formula (d) include divinylsilane, trivinylsilane, tetravinylsilane, dimethyldivinylsilane, methyltrivinylsilane, diethyldivinylsilane, ethyltrivinylsilane, diphenyldivinylsilane, phenyltrivinylsilane, diallylsilane, triallylsilane, tetraallylsilane, dimethyldiallylsilane, methyltriallylsilane, diethyldiallylsilane, ethyltriallylsilane, diphenyldiallylsilane, phenyltriallylsilane, dibutenylsilane, and dimethyldibutenylsilane.

The formula (e) is as follows:

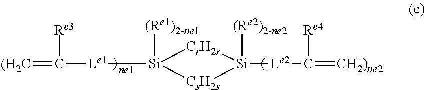

wherein,
R^{e1} and R^{e2} are each independently hydrogen, C₁₋₆ alkyl, C₁₋₆ alkenyl or C₆₋₁₂ aryl, preferably hydrogen or C₁₋₆ alkyl, more preferably methyl or hydrogen.
R^{e3} and R^{e4} are each independently hydrogen or C₁₋₆ alkyl, preferably hydrogen or methyl, more preferably hydrogen.
L^{e1}'s are each independently a single bond, C₁₋₆ alkylene or C₆₋₁₂ arylene, preferably a single bond or C₁₋₄ alkylene, more preferably a single bond or —CH₂—. Methylene in alkylene and arylene is not replaced or replaced with oxy, preferably is not replaced.
ne1 and ne2 are each independently 1 to 2, preferably 2.
r and s are each independently 1 to 3, preferably 1 or 2, and more preferably 1.

Exemplified embodiments of the silicon compound represented by the formula (e) include 1,3-divinyl-1,3-disilacyclobutane, 1, 1-divinyl-1,3-disilacyclobutane, 1,1,3-trivinyl-1,3-disilacyclobutane, 1,3-divinyl-1,3-dimethyl-1,3-disilacyclobutane, 1,1-divinyl-3,3-dimethyl-1,3-disilacyclobutane, 1-methyl-1,3,3-trivinyl-1,3-disilacyclobutane, 1,1,3,3-tetravinyl-1,3-disilacyclobutane, 1,3-diallyl-1,3-disilacyclobutane, 1,1-diallyl-1,3-disilacyclobutane, 1,1,3-triallyl-1,3-disilacyclobutane, 1,3-diallyl-1,3-dimethyl-1,3-disilacyclobutane, 1,1-diallyl-3,3-dimethyl-1,3-disilacyclobutane, 1-methyl-1,3,3-triallyl-1,3-disilacyclobutane, and 1,1,3,3-tetraallyl-1,3-disilacyclobutane.

The formula (f) is as follows:

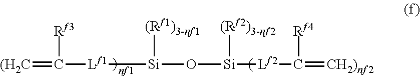

wherein,
R^{f1} and R^{f2} are each independently hydrogen, C₁₋₆ alkyl, C₁₋₆ alkenyl or C₆₋₁₂ aryl, preferably C₁₋₆ alkyl, more preferably methyl or ethyl.
R^{f3} and R^{f4} are each independently hydrogen or C₁₋₆ alkyl, preferably hydrogen or methyl, more preferably hydrogen.
L^{f1} and L^{f2} are each independently a single bond, C₁₋₆ alkylene or C₆₋₁₂ arylene, preferably a single bond or C₁₋₄ alkylene, more preferably a single bond or —CH₂—. Methylene in alkylene and arylene is not replaced or replaced with oxy, preferably is not replaced.
nf1 and nf2 are each independently 1 to 3, preferably 2.

Exemplified embodiments of the silicon compound represented by the formula (e) include 1,1,3,3-tetravinyldimethyldisiloxane, 1,1,3,3-tetravinyldiethyldisiloxane, 1,1,1,3,3,3-hexavinyldisiloxane, 1,1,3,3-tetramethyl-1,3-divinyldisiloxane, 1,1,3,3-tetraallyldimethyldisiloxane, 1,1,3,3-tetraallyldiethyldisiloxane, 1,1,1,3,3,3-hexaallyldisiloxane, and 1,1,3,3-tetramethyl-1,3-diallyldisiloxane.

The molar ratio of the silicon compound to the raw material polysilazane (the silicon compound/the raw material polysilazane) is preferably 0.5 to 10 and more preferably 0.75 to 8.

The reaction between the raw material polysilazane and the silicon compound is performed by heating or light irradiation in the presence of a reaction initiator.

Examples of the reaction initiator include 2,2′-azobis(isobutyronitrile), 2,2′-azobis(2-methylbutyronitrile), cumene hydroperoxide, 4,4′-azobis(4-cyanovaleric acid), 2,2′-azobis(2,4-dimethylvaleronitrile), 1,1′-azobis(cyclohexane-1-carbonitrile), 2,2′-azobis[2-(2-imidazoline-2-yl)propane]dihydrochloride, ammonium peroxodisulfate, tert-butyl hydroperoxide, benzoyl peroxide, dicumyl peroxide, di-tert-butyl peroxide, 2,2′-azobis(2-methylpropionamidine)dihydrochloride, 2,2′-azobis(2-methylpropionic acid)dimethyl, diisopropyl peroxydicarbonate, dipropyl peroxydicarbonate, benzoin, acetophenone, 4,4′-bis(diethylamino)benzophenone, benzoin isopropyl ether, 3′-hydroxyacetophenone, 2-methylbenzophenone, 9,10-phenanthrenequinone, benzoin isobutyl ether, dibenzoyl, dibenzosuberenone, benzoin ethyl ether, lithium phenyl (2,4,6-trimethylbenzoyl)phosphinate, camphorquinone, 4-hydroxybenzophenone, 4-phenylbenzophenone, 2-hydroxy-2-methylpropiophenone, 2-ethylanthraquinone, 4,4′-dihydroxybenzophenone, 4,4′-dimethylbenzyl, benzophenone, 4,4′-bis(dimethylamino)benzophenone, 3,3′,4,4′-benzophenone tetracarboxylic acid dianhydride, methyl benzoylformate, 2-benzoylbenzoic acid, 4,4′-dichlorobenzophenone, 2,2-diethoxyacetophenone, 2-methyl-4′-(methylthio)-2-morpholinopropiophenone, 2-hydroxy-4′-(2-hydroxyethoxy)-2-methylpropiophenone, 9,10-phenanthrenequinone, diphenyl(2,4,6-trimethylbenzoyl) phosphine oxide, 2-isopropylthioxanthone, 2,2-dimethoxy-2-phenylacetophenone, 1,4-dibenzoylbenzene, 3,4-dimethylbenzophenone, 4-benzoyl-4′-methyldiphenylsulfide, benzoin methyl ether, 2-benzoylmethyl benzoate, 2,2′-bis(2-chlorophenyl)-4,4′,5,5′-tetraphenyl-1,2′-biimidazole, 4-benzoylbenzoic acid, 4-(dimethylamino)benzophenone, ferrocene, p-anisyl, 3-hydroxybenzophenone, anthraquinone-2-sodium sulfonate, anthraquinone, anisoin, 4′-hydroxyacetophenone, phenylbis(2,4,6-trimethylbenzoyl) phosphine oxide, ethyl phenyl(2,4,6-trimethylbenzoyl)phosphinate, 2,2′-bis(2-chlorophenyl)-4,4′,5,5′-tetraphenyl-1,1′-biimidazole, bis[2,6-difluoro-3-(1H-pyrrole-1-yl)phenyl]titanocene, 1-chloro-4-propoxy-9H-thioxanthene-9-one, 2,7-dimethoxy-9H-thioxanthene-9-one, 2,7-dimethoxy-9H-thioxanthene-9-one, 1-([1,1′-biphenyl]-4-yl)-2-methyl-2-morpholinopropane-1-one, 4′-hydroxyacetophenone, acetophenone, 4,4′-bis(diethylamino)benzophenone, imidazoles, oxime esters, α-hydroxyalkylphenone, α-alkylaminophenone, benzyldimethylketal, acylphosphine oxide, triethylborane, chloro(1,5-cyclooctadiene)rhodium, (1,5-cyclooctadiene)ruthenium chloride, ruthenium acetylacetonate, dichloro(1,5-cyclooctadiene) palladium, hexachloroplatinic acid, platinum-1,3-divinyl-1,1,3,3-tetramethyldisiloxane complex, dichloro(1,5-cyclooctadiene) platinum, chlorotris(triphenylphosphine)rhodium, chloro(1,5-cyclooctadiene)rhodium dimer, chloro(triphenylphosphine)dicarbonylrhodium, nickel acetylacetonate, pyridine bis(oxazoline) cobalt complex, and bis(imino)pyridine cobalt. Preferred are 2,2′-azobis(isobutyronitrile), 1,1′-azobis(cyclohexane-1-carbonitrile), and triethylborane.

The heating temperature is preferably 50 to 120° C. and more preferably 60 to 100° C. The wavelength of light irradiation is preferably a peak wavelength of 150 to 450 nm and more preferably 240 to 440 nm.

### <Composition>

A composition according to the present invention comprises the above-described crosslinked polysilazane and a solvent.

The solvent is preferably at least one selected from the group consisting of aromatic compounds, saturated hydrocarbon compounds, unsaturated hydrocarbon compounds, ether compounds, ester compounds, and ketone compounds. In particular, the following are included: aromatic compounds (such as benzene, toluene, xylene, ethylbenzene, diethylbenzene, trimethylbenzene and triethylbenzene); saturated hydrocarbon compounds (such as cyclohexane, decahydronaphthalene, dipentene, n-pentane, i-pentane, n-hexane, i-hexane, n-heptane, i-heptane, n-octane, i-octane, n-nonane, i-nonane, n-decane, ethylcyclohexane, methylcyclohexane, cyclohexane and p-menthane); unsaturated hydrocarbon compounds (such as cyclohexene); ether compounds (such as dipropyl ether, dibutyl ether and anisole); ester compounds (such as n-butyl acetate, i-butyl acetate, n-amyl acetate and i-amyl acetate); and ketone compounds (such as methyl isobutyl ketone (MIBK)).

These can be used singly or in combination of two or more.

The composition according to the present invention comprises preferably 1 to 70 mass %, and more preferably 1 to 60 mass % of the crosslinked polysilazane, based on the total mass of the composition.

The composition according to the present invention can comprise optionally further components. These components are described following. The content of components other than the crosslinked polysilazane and the solvent in the entire composition is preferably 10% or less, more preferably 5% or less, and further preferably 1% or less, based on the total mass of the composition.

### <Optional Components>

Examples of the optional components include surfactants.

Since a surfactant can improve coatability, the surfactant is preferable to be used. Examples of the surfactant that can be used in the composition according to the present invention include nonionic surfactants, anionic surfactants, amphoteric surfactants, and the like.

Examples of the nonionic surfactant include polyoxyethylene alkyl ethers such as polyoxyethylene lauryl ether, polyoxyethylene oleyl ether and polyoxyethylene cetyl ether; polyoxyethylene fatty acid diester; polyoxy fatty acid monoester; polyoxyethylene polyoxypropylene block polymer; acetylene alcohol; acetylene glycol; acetylene alcohol derivatives such as polyethoxylate of acetylene alcohol; acetylene glycol derivatives such as polyethoxylate of acetylene glycol; fluorine-containing surfactants such as Fluorad (trade name, manufactured by 3M Japan Limited), MEGAFACE (trade name, manufactured by DIC Corporation), Surufuron (trade name, manufactured by Asahi Glass Co., Ltd.); and organosiloxane surfactants such as KP341 (trade name, manufactured by Shin-Etsu Chemical Co., Ltd.). Examples of said acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-hexyne-2,5-diol, and 2,5-dimethyl-2,5-hexane-diol.

Examples of the anionic surfactant include ammonium salt or organic amine salt of alkyl diphenyl ether disulfonic acid, ammonium salt or organic amine salt of alkyl diphenyl ether sulfonic acid, ammonium salt or organic amine salt of alkyl benzene sulfonic acid, ammonium salt or organic amine salt of polyoxyethylene alkyl ether sulfuric acid, and ammonium salt or organic amine salt of alkyl sulfuric acid.

Examples of the amphoteric surfactant include 2-alkyl-N-carboxymethyl-N-hydroxyethyl imidazolium betaine and lauric acid amide propyl hydroxysulfone betaine.

These surfactants can be used singly or as a mixture of two or more kinds, and the content thereof is usually 50 to 10,000 ppm, preferably 100 to 5,000 ppm, based on the total mass of the composition.

### <Method for Manufacturing Silicon-Containing Film>

A method for producing a silicon-containing film according to the present invention comprises:
forming a coating film above a substrate with the above-described composition; and
heating the coating film.

In the present invention, the “above a substrate” includes a case wherein the composition is applied directly on a substrate and a case wherein the composition is applied on a substrate via one or more intermediate layers.

The method for applying the composition to such a substrate can be selected from usual methods such as a spin coating, a dip coating, a spray coating, a transfer method, a roll coating, a bar coating, a doctor coating, a brush coating, a flow coating, or a slit coating and the like. As the substrate for applying the composition, any suitable substrate such as silicon substrate, glass substrate and resin film can be used. Various semiconductor devices and the like may be formed on these substrates as required. When the substrate is a film, gravure coating is also available. If desired, a drying step can be additionally provided after applying the film. If necessary, the coating step can be repeated twice or more to form a coating film having a desired film thickness.

After forming the coating film of the composition according to the present invention, for the purposes of drying the coating film and decreasing the remaining amount of solvent, prebaking may be carried out. The prebaking step can be carried out in an oxidizing atmosphere and a non-oxidizing atmosphere, preferably in the atmosphere of an inert gas for curing in a non-oxidizing atmosphere or air for curing in an oxidizing atmosphere, preferably at from 80 to 300° C., for 10 to 300 seconds on a hot plate or 1 to 30 minutes in a clean oven.

Then, the optionally prebaked coating film is cured by heating to form a silicon-containing film. This heating is preferably performed in an oxidizing atmosphere.

The heating is performed in a temperature range of preferably 200 to 700° C., more preferably 300 to 600° C.

The oxidizing atmosphere means an atmosphere in which oxygen partial pressure is 20 to 101 kPa, preferably 40 to 101 kPa and more preferably containing water vapor partial pressure of 1.5 to 80 kPa, when total pressure is 101 kPa.

There are sometimes concerns that the heating in an atmosphere containing water vapor at a high temperature, for example exceeding 600° C., affects other element such as an electronic device, which is simultaneously exposed to the heating treatment. In such a case, the heating step can be divided into two or more stages (more preferably three or more stages). For example, the heating can be carried out first in an oxidizing atmosphere at a low temperature (for example, a temperature range from 200 to 400° C.), second in an atmosphere containing water vapor at a relatively low temperature (for example, a temperature range from 300 to 600° C.), and subsequently in an atmosphere containing no water vapor at a higher temperature (for example, 400 to 800° C.).

Other components than water vapor in the atmosphere containing water vapor (hereinafter referred to as “dilution gas”) can be any gas, and examples thereof include air, oxygen, nitrogen, nitrous oxide, ozone, helium, and argon. In terms of quality of the obtained silicon-containing film, it is preferred to use oxygen as the dilution gas.

The heating rate to the target temperature and the cooling rate during the heating are not particularly limited and can be generally within a range from 1 to 100° C./min. Holding time after reaching the target temperature is not also limited in particular, and it can be generally within a range from 1 minute to 10 hours.

The film thickness of the silicon-containing film is preferably 1.0 to 4.0 μm and more preferably 1.0 to 3.5 μm.

The method for manufacturing an electronic device according to the present invention comprises the above described method. Preferably, the electronic device according to the present invention is a semiconductor device, a solar cell chip, an organic light emitting diode, or an inorganic light emitting diode. One preferred embodiment of the electronic device of the present invention is a semiconductor device.

### EXAMPLES

Hereinafter, the present invention will be described with reference to Examples. These Examples are given only for illustrative purpose and not intended to limit the scope of the present invention.

In the following Examples, the mass average molecular weight (Mw) is measured by gel permeation chromatography (GPC) in terms of polystyrene. GPC is measured using Alliance e2695 High Performance GPC system (Nihon Waters K.K.) and Super Multipore HZ-N GPC column (Tosoh Corporation). The measurement is performed using monodispersed polystyrene as a standard sample and chloroform as a developing solvent, under the conditions of a flow rate of 0.6 ml/min and a column temperature of 40° C., and thereafter calculating Mw as a relative molecular weight to the standard sample.

### <Synthesis of Polysilazane Intermediate A>

The inside of a 10 L reaction vessel, equipped with a cooling condenser, a mechanical stirrer and a temperature controller, is replaced with dry nitrogen and thereafter 7,500 ml of dry pyridine is put into the reaction vessel, which is then cooled down to −3° C. Subsequently, when 500 g of dichlorosilane is added, a white solid adduct (SiH₂Cl2·2C₅H₅N) is produced. Upon confirming that the reaction mixture becomes −3° C. or less, 350 g of ammonia is slowly blown into the reaction mixture while stirring. Subsequently, stirring is continued for 30 minutes, and then dry nitrogen is blown into the liquid layer for 30 minutes to remove excess ammonia. The resulting product in slurry form is subjected to pressure filtration through a 0.2 μm pore size Teflon (registered trademark) filter in a dry nitrogen atmosphere to obtain 6,000 ml of filtrate. Dry xylene (3,000 ml) is added, and pyridine is distilled off using an evaporator and concentrated to obtain a xylene solution of polysilazane having a concentration of 39.8%. Mw of the obtained polysilazane is 1,220 measured by gel permeation chromatography in terms of polystyrene. The polysilazane obtained by this formulation is hereinafter referred to as a polysilazane intermediate A.

### <Synthesis of Crosslinked Polysilazane A>

Into a 200 mL three-necked flask equipped with a magnetic stirrer bar, a nitrogen inlet, and a reflux condenser, 30.0 g of the polysilazane intermediate A in xylene, 0.78 g of tetravinylsilane as a crosslinking agent in 8 g of toluene, 0.35 g of azabisisobutyronitrile (AlBN) as a reaction initiator are put, and xylene is further added so that the content of the polysilazane intermediate A is 20 mass % to prepare a reaction solution. While stirring, N2 is blown thereto for 10 minutes (50 mL/min). Thereafter, the mixture is heated at 80° C. for 3 to 6 hours and concentrated at 40° C. under reduced pressure to obtain a crosslinked polysilazane A solution having a concentration of 40 mass %. Mw of the obtained crosslinked polysilazane A is 6,900.

### <Synthesis of Crosslinked Polysilazane B to H>

Crosslinked polysilazane B to H solutions are obtained in the same manner as in the synthesis of the crosslinked polysilazane A, except that the compounds of a polysilazane and a crosslinking agent and the addition amounts thereof, and the compound of a reaction initiator and the addition amount thereof are changed as described in Table 1. Each Mw is described in Table 1.

TABLE 1

| | | | | Reaction | | |
|---|---|---|---|---|---|---|
| | | Crosslinking agent | | initiator | | |
| | | | Addition | | Addition | |
| | Polysilazane | Compound | amount | Compound | amount | Mw |
| Crosslinked | Polysilazane | tetravinylsilane | 0.78 g | AIBN | 0.35 g | 6900 |
| polysilazane A | intermediate A | | | | | |
| Crosslinked | Polysilazane J | tetravinylsilane | 0.37 g | AIBN | 0.44 g | 15800 |
| polysilazane B | | | | | | |
| Crosslinked | Polysilazane | tetravinylsilane | 1.84 g | AIBN | 1.31 g | 16300 |
| polysilazane C | intermediate A | | | | | |
| Crosslinked | Polysilazane | tetravinylsilane | 2.94 g | AIBN | 1.40 g | 18400 |
| polysilazane D | intermediate A | | | | | |
| Crosslinked | Polysilazane J | tetraallylsilane | 2.60 g | AIBN | 0.35 g | 16200 |
| polysilazane E | | | | | | |
| Crosslinked | Polysilazane J | 1,1,3,3-tetravinyl- | 1.04 g | AIBN | 0.35 g | 14200 |
| polysilazane F | | 1,3- | | | | |
| | | disilacyclobutane | | | | |
| Crosslinked | Polysilazane J | 1,1,3,3- | 1.14 g | AIBN | 0.35 g | 11500 |
| polysilazane G | | tetravinyldimethyl | | | | |
| | | disiloxane | | | | |
| Crosslinked | Polysilazane J | dimethyldivinylsilane | 0.60 g | AIBN | 0.35 g | 12100 |
| polysilazane H | | | | | | |

### <Synthesis of Polysilazane I>

After the inside of a 10 L reaction vessel, equipped with a cooling condenser, a mechanical stirrer and a temperature controller, is replaced with dry nitrogen, 4,710 g of dry pyridine, 150 g of dry xylene, and 1,650 g of the polysilazane intermediate A obtained above having a concentration of 39.8% are put into the reaction vessel, and the mixture is stirred to be uniform while bubbling with 0.5 NL/min of a nitrogen gas. Subsequently, the modification reaction is performed at 110° C. for 8.6 hours to obtain a polysilazane I. Pyridine is distilled off to obtain a polysilazane I solution.

The polysilazane I is perhydropolysilazane and Mw thereof is 5,800.

### <Synthesis of Polysilazane J>

A polysilazane J is obtained by performing synthesis while the conditions of the modification reaction are changed to 110° C. for 10.0 hours with respect to the synthesis of the polysilazane I. The polysilazane J is perhydropolysilazane and Mw thereof is 8,300.

Crosslinked polysilazane A to H are identified as crosslinked perhydropolysilazane from measurements of an infrared absorption spectrum using FTIR6100 (JASCO Corporation), ¹³C-NMR, and ²⁹Si-NMR.

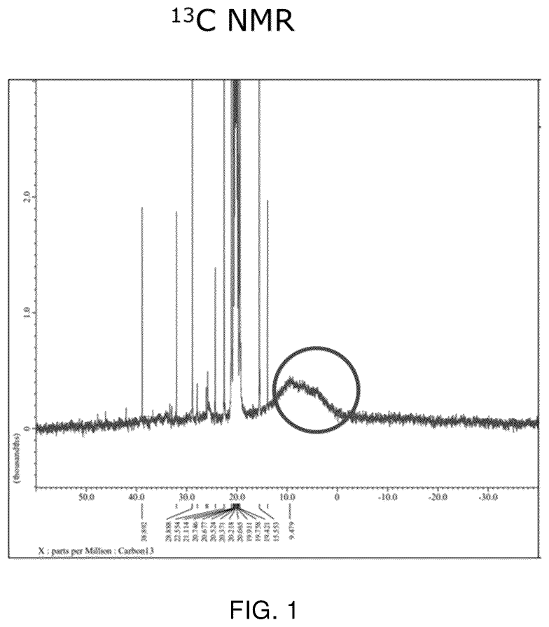

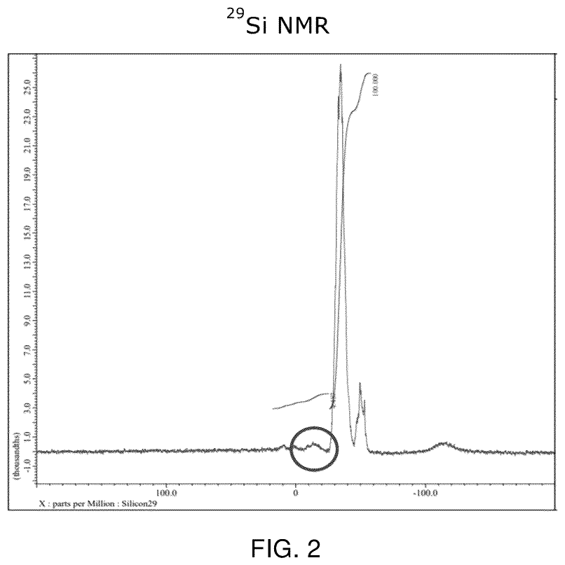

FIG. 1 shows 13C-NMR of the crosslinked polysilazane A, and a peak attributed to —CH₂— is confirmed near 9 ppm. FIG. 2 shows ²⁹Si-NMR of the crosslinked polysilazane A, a peak due to formation of a new Si bond near −15 ppm is confirmed, and it is found that Si—CH₂— is generated.

### EXAMPLE 1

A composition of Example 1 is prepared by using the crosslinked polysilazane A synthesized above and xylene so that the concentration of the crosslinked polysilazane A becomes 40 mass %.

The composition of Example 1 is applied to a 4-inch Si substrate pre-wet with xylene using a spin coater (1HDX2, Mikasa Co. Ltd.) to form a coating film. The obtained coating film is heated (prebaked) at 150° C. for 3 minutes on a hot plate. The film thickness (film thickness after prebaking) at this time is measured to be 2.4 μm. The prebaked coating film is heated (cured) at 350° C. for 30 minutes in a water vapor atmosphere, and further heated (annealed) at 850° C. for 30 minutes in a nitrogen atmosphere to obtain a silicon-containing film of Example 1. The film thickness (film thickness after annealing) at this time is 2.0 μm.

The film thickness is measured at 17 points on the diameter using a reflection spectroscopic thickness meter (FE-3000 manufactured by OTSUKA ELECTRONICS CO., LTD.), and the average value thereof is taken as the film thickness.

### Examples 2 to 8 and Comparative Example 1

Silicon-containing films of Examples 2 to 8 and Comparative Example 1 are obtained in the same manner as in Example 1, except that the composition to be used is changed to the crosslinked polysilazane (polysilazane in the case of Comparative Example 1) and the content thereof described in Table 2.

TABLE 2

| | | | | Film | Film | |
|---|---|---|---|---|---|---|
| | | | Content of the | thickness | thickness | |
| | | | crosslinked | after | after | |
| | Crosslinked | | polysilazane | prebaking | annealing | |
| | polysilazane | Solvent | (mass %) | (μm) | (μm) | Crack |
| Example 1 | Crosslinked | xylene | 40 | 2.4 | 2.0 | B |
| | polysilazane A | | | | | |
| Example 2 | Crosslinked | xylene | 40 | 3.1 | 2.6 | A |
| | polysilazane B | | | | | |
| Example 3 | Crosslinked | xylene | 35 | 2.5 | 2.1 | A |
| | polysilazane C | | | | | |
| Example 4 | Crosslinked | xylene | 35 | 2.6 | 2.2 | B |
| | polysilazane D | | | | | |
| Example 5 | Crosslinked | xylene | 35 | 2.9 | 2.4 | A |
| | polysilazane E | | | | | |
| Example 6 | Crosslinked | xylene | 35 | 2.8 | 2.4 | A |
| | polysilazane F | | | | | |
| Example 7 | Crosslinked | xylene | 35 | 2.6 | 2.0 | B |
| | polysilazane G | | | | | |
| Example 8 | Crosslinked | xylene | 38 | 2.4 | 2.1 | A |
| | polysilazane H | | | | | |
| Comparative | Polysilazane I | xylene | 25 | 1.8 | 1.5 | D |
| Example 1 | | | | | | |

### Cracks

Cracks in each of the above-mentioned silicon-containing films are observed with an optical microscope and evaluated according to the following criteria. The obtained results are as shown in Table 2.
A: No crack is observed.
B: Cracks are slightly observed.
C: Cracks are partially observed.
D: Cracks are entirely observed.

The invention claimed is:

1. A crosslinked polysilazane comprising a repeating unit represented by the formula (1): 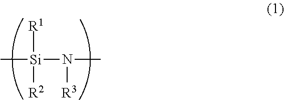
wherein,
R¹ and R² are each independently a single bond, hydrogen, C₁₋₄ alkyl or a linking group represented by the formulae (a) to (c), and when R¹ and R² are a single bond, they are bonded to N contained in other repeating units, and in the crosslinked polysilazane molecule, at least two of R¹ and R² are linking groups represented by the formulae (a) to (c);
R³ is a single bond, hydrogen or C₁₋₄ alkyl, and when R³ is a single bond, it is bonded to Si contained in other repeating units: 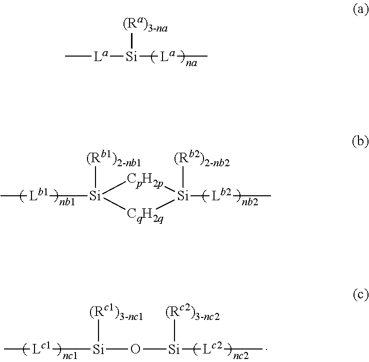
wherein R^{a}, R^{b1}, R^{b2}, R^{c1} and Rc2 are each independently hydrogen, C₁₋₆ alkyl, C₁₋₆ alkenyl or C₆₋₁₂ aryl;
L^{a}, L^{b1}, L^{b2}, L^{c1} and L^{c2} are each independently C₂₋₈ alkylene or C₆₋₁₄ arylene, in which the methylene in the alkylene and the arylene is not replaced or is replaced with oxy, provided that when it is replaced with oxy, the oxy is not directly bonded to Si of the formula (1);
na is 1 to 3;
nb1 and nb2 are each independently 1 to 2;
nc1 and nc2 are each independently 1 to 3;
p and q are each independently 1 to 3; and
among the bonds of the linking groups of the formulae (a) to (c), the bonds that are not bonded to Si of the formula (1) are bonded to Si contained in other repeating units.

2. The crosslinked polysilazane according to claim 1, wherein R¹ and R² are each independently a single bond, hydrogen or a linking group represented by the formulae (a) to (c), and R³ is a single bond or hydrogen.

3. The crosslinked polysilazane according to claim 1, which has a mass average molecular weight of 3,000 to 50,000 in terms of polystyrene as measured by the gel permeation chromatography.

4. The crosslinked polysilazane according to claim 1, wherein the number of Si atoms derived from the formulae (a) to (c) contained in the crosslinked polysilazane is 0.5 to 10.0% based on the total number of Si atoms in the crosslinked polysilazane.

5. A method for manufacturing a crosslinked polysilazane, comprising heating or irradiating with light, in the presence of a reaction initiator, a polysilazane comprising a repeating unit represented by the formula (2) and at least two Si—H bonds; and
at least one silicon compound represented by the formulae (d) to (f): 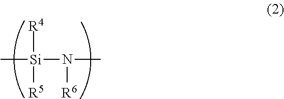
wherein,
R⁴ and R⁵ are each independently a single bond, hydrogen or C₁₋₄ alkyl, and when R⁴ and R⁵ are a single bond, they are bonded to N contained in other repeating units; and
R⁶ is a single bond, hydrogen or C₁₋₄ alkyl, and when R⁶ is a single bond, it is bonded to Si contained in other repeating units; and 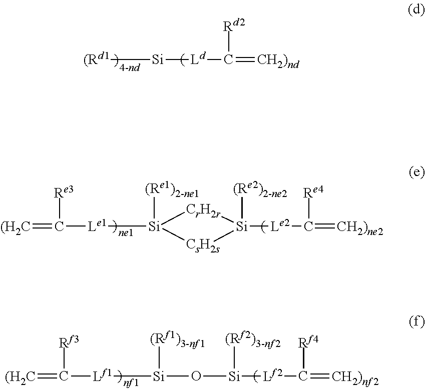
wherein R^{d1}, R^{e1}, R^{e2}, R^{f1} and R^{f2} are each independently hydrogen, C₁₋₆ alkyl, C₁₋₆ alkenyl or C₆₋₁₂ aryl;
R^{d2}, R^{e3}, R^{e4}, R^{f3} and R^{f4} are each independently hydrogen or C₁₋₆ alkyl;
L^{d}, L^{e1}, L^{e2}, L^{f1} and L^{f2} are each independently a single bond, C₁₋₆ alkylene or C₆₋₁₂ arylene, in which the methylene of the alkylene and the arylene is not replaced or replaced with oxy;
nd is 2 to 4;
ne1 and ne2 are each independently 1 to 2;
nf1 and nf2 are each independently 1 to 3; and
r and s are each independently 1 to 3.

6. The method according to claim 5, wherein the polysilazane is perhydropolysilazane.

7. A composition comprising the crosslinked polysilazane according to claim 1 and a solvent.

8. The composition according to claim 7, wherein the solvent is at least one selected from the group consisting of aromatic compounds, saturated hydrocarbon compounds, unsaturated hydrocarbon compounds, ether compounds, ester compounds and ketone compounds.

9. The composition according to claim 7, wherein the content of the crosslinked polysilazane is 1 to 70 mass % based on the total mass of the composition.

10. A method for manufacturing a silicon-containing film, comprising:
forming a coating film above a substrate using the composition according to claim 7; and
heating the coating film.

11. The method for manufacturing a silicon-containing film according to claim 10, wherein the heating is performed in an oxidizing atmosphere.

12. A silicon-containing film obtained by the method according to claim 10.

13. An electronic device comprising the silicon-containing film according to claim 12.

14. A method for manufacturing an electronic device, comprising the method according to claim 10.
